(19) United States
(12) Patent Application Publication
(10) Pub. No.: US 2007/0287790 A1
(43) Pub. Date: Dec. 13, 2007

(54) FORMED RESINOUS ARTICLE COMPRISING SPECIAL VISUAL EFFECT ADDITIVE

(76) Inventors: Douglas Warren Howie, Parkersburg, WV (US); Olga Kuvshinnlkova, Glenmont, NY (US); Patrick Rodgers, Vienna, WV (US)

Correspondence Address: SABIC - ESR;SABIC Innovative Plastics - IP Legal, ONE PLASTICS AVENUE, PITTSFIELD, MA, 01201-3697, US

(21) Appl. No.: 11/423,039

(22) Filed: Jun. 8, 2006

(51) Int. Cl. C09B 67/00

(52) U.S. Cl. 524/502; 524/522; 524/523; 524/533; 524/495; 524/497; 524/847; 428/357; 428/363; 428/557; 106/31.33; 106/31.65; 106/636; 106/784; 106/814

(57) ABSTRACT

The present invention relates to formed resinous articles derived from compositions comprising an ASA resin and a special visual effect additive.

### BACKGROUND

The present invention relates to formed resinous articles derived from compositions comprising an ASA resin and a special visual effect additive and having improved appearance in formed parts.

Current trends in consumer products have created an unprecedented demand for plastic articles having unique color and surface appearance. For example, cellular telephones having interchangeable plastic covers are now commonly available. These covers come in a variety of colors and/or special visual effects, giving consumers control over the aesthetic design of their phones. Many other injection molded plastic products, such as, for example, computers, stereos and other consumer and/or business equipment, automotive interiors, and the like, also benefit from having unique color and surface appearance. Plastic articles having a special visual effect, such as a sparkling look, a metallescent or metal-like look, a true metal appearance, a hammered metal appearance, or any angular metameric appearance are desirable in many instances. Plastic articles having a sparkling or metallescent look can be created by incorporating a special visual effect additive such as free metal flakes into a plastic article at such loading that the individual flakes can be distinguished by the naked eye, resulting in an article with a sparkling or metallescent appearance.

Glass-filled thermoplastic resins containing special visual effect additives such as aluminum flakes have been disclosed by GE Plastics under the tradename ALLIAGE®. Molded parts of such glass-filled resins show a differentiated metallic look resembling a hammered metal surface. In principal, larger metal flakes should produce a showier, higher contrast, metallic special effect appearance and using the largest flakes possible should enhance a hammered metal surface look. However, at larger metal flake sizes the hammered metal appearance is lost, making it difficult to simultaneously enhance the contrast of the desired surface effect and maintain the hammered metal appearance. As a consequence, only metal flakes in the range from 10-20 microns have typically been used. Compositions continue to be sought which improve the contrast between metal flake and resin matrix while retaining a special visual effect in a molded part, such as a hammered metal appearance.

### BRIEF DESCRIPTION

The present inventors have discovered a means for enhancing the contrast between metal flake and resin matrix while retaining a special visual effect in a formed part, such as a hammered metal appearance. In one embodiment the invention comprises a formed article exhibiting a special visual effect derived from a composition comprising (i) at least one of an ASA resin or a methyl methacrylate-modified ASA resin present in an amount in a range of between about 10 phr and about 80 phr, (ii) at least one thermoplastic resin selected from the group consisting of SAN, MMASAN, AMSAN, and PMMA, (iii) at least one of glass roving or glass fiber present in an amount in a range of between about 2 phr and about 25 phr, and (iv) a mixture of special visual effect additives selected from the group consisting of metallic flakes, dyed metallic flakes, mineral flakes, dyed mineral flakes, mineral flakes with a metallic coating, and mineral flakes with a metal oxide coating, wherein the mixture comprises at least two different mean particle sizes of additives with one size ranging from about 12 to about 25 microns and another size of greater than about 30 microns, wherein the mixture is present in a total amount in a range of between about 0.05 phr and about 8 phr, and wherein the ratio of the number of particles per unit volume of a special visual effect additive of larger mean particle size to the number of particles per unit volume of a special visual effect additive of smaller mean particle size is in a range of between about 0.1 and about 1.

In another embodiment the invention comprises a formed article exhibiting a special visual effect derived from a composition comprising (i) at least one of an ASA resin or an methyl methacrylate-modified ASA resin present in an amount in a range of between about 10 phr and about 80 phr, (ii) at least one thermoplastic resin selected from the group consisting of SAN, MMASAN, AMSAN, and PMMA, (iii) at least one of glass roving or glass fiber present in an amount in a range of between about 2 phr and about 25 phr, (iv) mica present in an amount in a range of between about 1 phr and about 10 phr, and (v) an acrylic copolymer resin processing aid present in an amount in a range of between about 2 phr and about 10 phr.

Various other features, aspects, and advantages of the present invention will become more apparent with reference to the following description and appended claims.

### DETAILED DESCRIPTION

In the following specification and the claims which follow, reference will be made to a number of terms which shall be defined to have the following meanings. The singular forms “a”, “an” and “the” include plural referents unless the context clearly dictates otherwise.

Thermoplastic resins suitable as resinous components in embodiments of compositions of the present invention include, but are not limited to, polypropylenes, low density polyethylenes (LDPE), high density polyethylenes (HDPE), polypropylenes (PP), polystyrenes (PS), styrene-acrylonitrile copolymers (SAN), alpha-methylstyrene-acrylonitrile copolymers (AMSAN), polycarbonates (PC), bisphenol A polycarbonates, polyesters, poly(ethylene terephthalates), poly(trimethylene terephthalates), poly(butylene terephthalates), polyamides, acrylonitrile-ethylene-styrene copolymers (AES), acrylonitrile-butadiene-styrene copolymers (ABS), acrylate-modified ABSS, acrylonitrile-styrene-acrylate copolymers (ASA), methyl methacrylate-modified ASAs, methyl methacrylate-butyl acrylate copolymers (MMASAN), acetals, acrylics, poly(methyl methacrylates) (PMMA), cellulose acetates, cellulose acetate butyrates, ethylene vinyl acetates, fluoropolymers, polyphenylene sulfides, polyetherimides, polyimides, polyphenylene ethers, poly(2,6-dimethyl-1,4-phenylene ethers), thermoplastic polyurethanes, polysulfones, polyamides, polyethersulfones, polyarylsulfones, polyphenylsulfones, polyetherketones, polyetheretherketones, and like resins prepared by an addition or condensation process. Blends comprising at least one of these resins are also within the scope of the invention. Illustrative examples of blends include, but are not limited to, polyphenylene ether blends with polystyrene, polyphenylene ether blends with polyamide, ABS or acrylate-modified ABS blends with polycarbonate, ABS or acrylate-modified ABS blends with PMMA, ABS or acrylate-modified ABS blends with SAN, ASA or methyl methacrylate-modified ASA blends with polycarbonate, ASA or methyl methacrylate-modified ASA blends with PMMA, ASA or methyl methacrylate-modified ASA blends with MMASAN, ASA or methyl methacrylate-modified ASA blends with AMSAN, and ASA or methyl methacrylate-modified ASA blends with SAN. Also, any of these thermoplastic resins or blends may be used as a carrier resin in producing concentrates of one or more special visual effect additives as described hereinafter.

In one embodiment a suitable thermoplastic resin comprises a rubber modified thermoplastic resin. In another embodiment a suitable rubber modified thermoplastic resin may comprise a rigid thermoplastic phase with structural units derived from a monomer mixture comprising at least one vinyl aromatic monomer and at least one monoethylenically unsaturated nitrile monomer and an elastomeric phase with structural units derived from at least one monoethylenically unsaturated alkyl (meth)acrylate monomer. Collectively, these types of rubber modified thermoplastic resins are known as ASA-type resins. When ASA-type resins are employed, they may be present in compositions of the invention in an amount in a range of between about 10 parts per hundred parts resin by weight (phr) and about 80 phr, and preferably in an amount in a range of between about 35 phr and about 65 phr.

Additives which provide special visual effects in compositions in embodiments of the invention comprise those which provide at least one of a sparkle effect, a metallic sparkle, a metallic luster, a metallescent effect, an angular metamerism effect, a pearlescent effect, an appearance resembling stone or resembling granite, a hammered metal effect, or like effect. In one embodiment special visual effect additives comprise at least two different particle sizes of additives. Formed parts of compositions comprising additives comprising particles such as metal flakes of at least two different sizes typically show greater variation in color per unit area and a desirably coarser texture when compared to formed parts of compositions having only one particle size.

In an embodiment suitable special visual effect additives comprise mineral flakes, metallic flakes, or mineral flakes with a metallic or metal oxide coating. The flakes typically have a mean particle size ranging from about 1 to about 3500 microns, preferably from about 10 to about 700 microns, more preferably from about 10 to about 300 microns, and still more preferably from about 10 to about 100 microns. The preferred mineral flakes are mica flakes. In one embodiment, when a mixture of flakes of two different mean particle sizes is employed, then one has particle size ranging from about 12 to about 25 microns and the other has particle size of greater than about 30 microns. Preferred flakes are based on metals of Groups 4, 6, 8, 9, 10, 11, 13, and 14 of the periodic table of the elements. The flakes may be colored or dyed. Examples of flakes include, but are not limited to, aluminum, bronze, brass, chromium, copper, gold, iron, molybdenum, nickel, tin, titanium, zinc and the like. Metallic flake may be produced by shredding to give a broad distribution of irregular particle shapes, or by die-cutting to give more limited particle size and shape. A “cornflake” type or corrugated irregularly shaped planar metallic flake such as of aluminum or bronze may be utilized, although a “silver dollar” type or a circular planar type of flake may also be utilized as metallic flake. Glitter, which is a special type of aluminum flake produced from foil, may also be utilized. The foil, typically rolled to gauges of less than 0.025 mm, is typically cut into square, rectangular or hexagonal shapes in sizes from 0.2 to about 3 mm, and typically coated with a transparent epoxy lacquer to halt oxidative dulling of the foil. Glitter, with its large particle sizes, can produce discrete highlights of metallic sparkle. Gold bronzes are typically alloys of copper and zinc with a small amount of aluminum to reduce oxidation. The range of gold colors is produced by varying proportions of major alloy components. In various examples a green gold alloy typically contains 70 percent copper, and color becomes redder as the percentage of copper is increased; 90 percent copper produces pale gold; deep gold is made by controlled oxidation of the alloys. Gold bronzes are usually utilized in flake form, with coarser grades giving more brilliance. Metallic flakes such as copper must be utilized with care, however, as they may be susceptible to heat, moisture and corrosives. The metallic flake may optionally be coated, for example, with rosin or fatty acids, such as oleic or linoleic acid. Optionally, the special visual effect additive may be initially in granular or pellet form comprising a carrier material, which may optionally comprise at least one polymer. Suitable carrier materials comprise mineral oil, wax, polyethylene, oxidized polyethylene, poly(methyl methacrylate), or the like. In granular form the special visual effect additive typically represents about 70-80% of the granule with the remainder being the carrier. The special visual effect additives can be used to produce or enhance bright sparkle as well as hammer and leafing finishes in formed composites of the invention. Illustrative examples of suitable special visual effect additives may comprise those with the tradename SILVET® available from Silberline Manufacturing Co., Tamaqua, Pa.; those with the tradenames IRIODIN®, COLORSTREAM®, XIRALLIC®, BI-FLAIR®, and MINATEC® available from EMD Chemicals, Hawthorne, N.Y.; and glitter products available from Meadowbrook Inventions, Inc., Bernardsville, N.J.

At least one additive which provides a special visual effect is used in compositions of the invention in one embodiment in a total amount in a range of between about 0.005 phr and about 25 phr, depending upon such factors as whether the resinous composition is substantially clear or opaque. For example, when the resinous composition is clear, less of an additive providing a special visual effect is used than when the resinous composition is opaque. As little as 0.01 phr of a special visual effect additive may be employed in clear resinous compositions. In some embodiments at least one special visual effect additive is used in compositions of the invention in a total amount in a range of between about 0.01 phr and about 10 phr, or in an amount in a range of between about 0.05 phr and about 8 phr, with about 0.5-4 phr being preferred. In other embodiments mica may be present in compositions of the invention in an amount in a range of between about 1 phr and 10 phr, and preferably in an amount in a range of between about 2 phr and 6 phr.

When two or more special visual effect additives are present in a composition, a convenient method to describe their relative amounts is by ratio of number of particles per unit volume. A special visual effect additive of smaller particle size typically has a higher number of particles per unit volume than a special visual effect additive of larger particle size. In some compositions of the invention the ratio of the number of particles per unit volume of a special visual effect additive of larger mean particle size to the number of particles per unit volume of a special visual effect additive of smaller mean particle size is in one embodiment in a range of between about 0.1 and about 1, and in another embodiment in a range of between about 0.5 and about 0.8. In other compositions of the invention the ratio of the weight of a special visual effect additive of larger mean particle size to the weight of a special visual effect additive of smaller mean particle size is in one embodiment less than or equal to 0.7.

Compositions in some embodiments of the invention may optionally comprise glass fibers, glass roving, glass spheres, microsphere beads, or particles of crosslinked polymer such as crosslinked acrylic resin, or the like, or mixtures comprising at least one of such additives. In some embodiments microsphere beads may have a diameter in a range of about 1 to about 1300 microns, typically in a range of about 1 to about 850 microns, and more typically in a range of about 10 to about 200 microns. In an embodiment the beads are comprised of glass and have a diameter of about 50 microns. In another embodiment the beads are comprised of barium titanate. In some embodiments optional glass roving or glass fibers or mixtures thereof may be present in compositions of the invention at a level in a range of between at least 1 part per hundred parts of resinous components (phr) and less than about 30 phr. In other embodiments optional glass roving or glass fibers or mixtures thereof may be present in compositions of the invention at a level in a range of between about 2 phr and about 25 phr, and preferably in a range of between about 2 phr and 8 phr.

Compositions of the present invention optionally comprise one or more additives known in the art which do not substantially interfere with the special visual effects. Such optional additives include, but are not limited to, stabilizers, such as color stabilizers, heat stabilizers, light stabilizers, antioxidants, UV screeners, and UV absorbers; flame retardants, anti-drip agents, nucleating agents, lubricants, flow promoters, rheology modifiers, and other processing aids; plasticizers, antistatic agents, mold release agents, impact modifiers, fillers, and colorants such as dyes and pigments which may be organic, inorganic or organometallic; and like additives. In particular embodiments illustrative additives include, but are not limited to, silica, silicates, zeolites, titanium dioxide, stone powder, glass fibers, glass spheres, glass roving, carbon fibers, carbon black, graphite, calcium carbonate, talc, lithopone, zinc oxide, zirconium silicate, iron oxides, diatomaceous earth, calcium carbonate, magnesium oxide, chromic oxide, zirconium oxide, aluminum oxide, crushed quartz, clay, calcined clay, talc, kaolin, asbestos, cellulose, wood flour, cork, cotton and synthetic textile fibers, and especially reinforcing fillers such as glass fibers, carbon fibers, or metal fibers. One or more optional additives may be present in compositions of the invention in an effective amount to achieve their desired function.

Illustrative processing aids comprise (i) ethylene bisstearamide, (ii) an acrylic copolymer resin, such as acrylic rubber-modified acrylic resins, for example METABLEN® modifiers available from Mitsubishi Rayon Co.; (iii) a thermoplastic resin, particularly a high molecular weight resin, comprising structural units derived from styrene and acrylonitrile and optionally methyl methacrylate, for example BLENDEX® modifiers available from Crompton Corporation; (iv) a fluoropolymer, such as, but not limited to, poly(tetrafluoroethylene), optionally encapsulated in a resin matrix, illustrative examples of which matrices include resins comprising structural units derived from styrene and acrylonitrile and optionally methyl methacrylate as described, for example in U.S. Pat. No. 5,962,587; and (v) like materials. In some embodiments, when present, ethylene bisstearamide may comprise an amount of a composition of the invention in a range of between about 0.5 phr and about 3 phr, and preferably an amount in a range of between about 1 phr and about 2 phr. In other embodiments, when present, an acrylic copolymer resin processing aid may comprise an amount of a composition of the invention in a range of between about 2 phr and about 10 phr, and preferably an amount in a range of between about 3 phr and about 6 phr.

Often more than one additive known in the art which does not substantially interfere with the special visual effect may be present in compositions of the invention, including in some embodiments more than one such additive of a particular type. In a particular embodiment a composition of the invention optionally comprises at least one additive selected from the group consisting of colorants, dyes, pigments, lubricants, processing aids, stabilizers, heat stabilizers, light stabilizers, antioxidants, UV screeners, UV absorbers, fillers, glass fibers, glass roving, poly(tetrafluoroethylene), and mixtures thereof. In another particular embodiment a composition of the invention comprises at least one colorant which is an organic additive present at a level in a range of between about 0.01 phr and about 1 phr. In another particular embodiment a composition of the invention comprises at least one colorant which is an inorganic additive present at a level or less than about 2 phr and preferably in a range of between about 0.01 phr and about 2 phr.

In one embodiment the compositions of the present invention are prepared by combining all of the blend components to form a first mixture. The mixing can be typically carried out in any conventional mixer like drum mixers, ribbon mixers, vertical spiral mixers, Muller mixers, Henschel mixers, sigma mixers, chaotic mixers, static mixers or the like. The first mixture is then compounded under melt-mixing conditions using any conventional method, such as extrusion kneading or roll kneading, a two-roll mill, in a Banbury mixer or in a single screw or twin-screw extruder, or in any high shear mixing device to mix the components to produce an intimate mixture, and optionally, to reduce the composition so formed to particulate form, for example, by pelletizing or grinding the composition. The twin screw extruder, when employed, can be co-rotating, counter rotating, intermeshing, non-intermeshing, a planetary gear extruder, a co-continuous mixer, or the like. The compounding process can be a continuous, semi-continuous, or a batch process. In other embodiments all or a portion of one or more blend components, either neat or combined with a portion of thermoplastic resin, may be added to the composition at some stage of a blending process, such as to a barrel segment down-stream of the feed-throat in an extrusion process. Those of ordinary skill in the art will be able to adjust blending times, as well as component addition location and sequence, without undue additional experimentation. Also optionally, a portion of some thermoplastic resin may be intimately mixed with special visual effect additive or other additive or both either separately or together, to prepare one or more master batches, and then the remaining thermoplastic resin and any other components may be combined therewith for formation of an intimate mixture. In one particular embodiment a thermoplastic resin is compounded with one or more special visual effect additives and provided in the form of pellets which are then combined and compounded with other blend components using methods described herein.

Articles comprising compositions described herein are also embodiments of the invention. Said articles include, but are not limited to, those typically used in applications requiring special visual effect properties. In some embodiments the articles comprise unitary articles. In still other embodiments the articles may comprise a sheet or film comprising a composition of the present invention. In other embodiments the articles may comprise a multilayer article comprising at least one layer comprising a composition of the present invention. Some particular suitable articles comprise outdoor and indoor signs, highway signs, traffic signs, horizontal signs, surface markers, guard rails, Jersey barriers; traffic barrels, tubes, and cones; and pavement or road markers and lines. Additional articles include, but are not limited to, articles for outdoor vehicle and device (OVAD) applications; exterior and interior components for aircraft, automotive, truck, military and emergency vehicles (including automotive, and water-borne vehicles), scooter, and motorcycle, including panels, quarter panels, rocker panels, vertical panels, horizontal panels, trim, pillars, center posts, fenders, doors, decklids, trunklids, hoods, bonnets, roofs, fascia, grilles, mirror housings, pillar appliques, cladding, body side moldings, wheel covers, door handles, spoilers, window frames, headlamp bezels, tail lamp housings, tail lamp bezels, license plate enclosures, and roof racks; enclosures, housings, panels, and parts for outdoor vehicles and devices; enclosures for electrical and telecommunication devices; outdoor furniture; aircraft components; boats and marine equipment, including trim, enclosures, and housings; outboard motor housings; depth finder housings, personal water-craft; jet-skis; pools; spas; hot-tubs; steps; step coverings; building and construction applications such as glazing, fencing, decking planks, roofs; siding, particularly vinyl siding applications; floors, windows, decorative window furnishings or treatments; wall panels, and doors; enclosures, housings, panels, and parts for desk-top, portable or hand-held computers; enclosures, housings, panels, and parts for automatic teller machines (ATM); enclosures, housings, panels, and parts for stereos, tape players, ipod® and other consumer electronic equipment; enclosures, housings, panels, and parts for lawn and garden tractors, lawn mowers, and tools, including lawn and garden tools; window and door trim; sports equipment and toys; enclosures, housings, panels, and parts for recreational vehicle panels and components, such as snowmobiles; playground equipment; articles made from plastic-wood combinations; golf course markers; utility pit covers; mobile phone housings; radio sender housings; radio receiver housings; light fixtures; lighting appliances; reflectors; network interface device housings; transformer housings; air conditioner housings; cladding or seating for public transportation; cladding or seating for trains, subways, or buses; meter housings; antenna housings; cladding for satellite dishes; and like applications.

Articles comprising compositions of the invention may be prepared by known thermoplastic processing techniques. Such processing techniques for forming articles include, but are not limited to, extrusion, kneading, profile extrusion, sheet extrusion, coextrusion, molding, extrusion blow molding, thermoforming, injection molding, co-injection molding and rotomolding. The invention further contemplates further optional fabrication operations on said articles, such as, but not limited to, in-mold decoration, baking in a paint oven, surface etching, lamination, and/or thermoforming. In a particular embodiment articles of the invention are made by an injection molding process. Articles made in textured molds or in molds comprising a shim are also encompassed in embodiments of the invention.

The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner. In the following examples ASA comprised 45 wt. % elastomeric phase comprising structural units derived from butyl acrylate, and 55 wt. % grafted thermoplastic phase comprising structural units derived from 30.1% styrene, 13.7% acrylonitrile and 11.1% methyl methacrylate (wt./wt./wt. ratio totaling 55). MMASAN resin comprised structural units derived from 35 wt. % methyl methacrylate (MMA), 40 wt. % styrene (S), and 25 wt. % acrylonitrile (AN). “Aluminum flake 1” had an average particle size of about 15-18 microns and was provided as pellets of aluminum flake contained in a carrier of polyethylene wax with a ratio of about 70% A1 to about 30% wax available as SPARKLE SILVET® 960-30-E1 from Silberline Co., Tamaqua, Pa. “Aluminum flake 2” had an average particle size of about 40 microns and was provided as pellets of aluminum flake contained in a carrier of PMMA with a ratio of about 80% A1 to about 20% PMMA available as SPARKLE SILVET® ST790-20-P from Silberline Co., Tamaqua, Pa. “Aluminum flake 3” had an average particle size of about 85 microns and was provided as pellets of aluminum flake contained in a carrier of polyethylene wax with a ratio of about 70% A1 to about 30% wax available as SILVET® 440-30-E1 from Silberline Co., Tamaqua, Pa.

### EXAMPLE 1

A resinous composition was prepared comprising (i) 35 parts per hundred parts resin (phr) ASA powder, (ii) 65 phr MMASAN pellets, (iii) 0.5 phr aluminum flake 1, (iv) 1.5 phr aluminum flake 2, and (v) 6.5 phr glass roving. The composition also comprised (vi) 1.65 phr of an additive package comprising a lubricant, heat stabilizers, and anti-oxidants which did not significantly affect the appearance of molded parts. The composition was compounded by extrusion and evaluated by injection molding into test parts. Photographs of plaques of the molded composition showed greater variation in color per unit area and appeared to have a coarser texture when compared to photographs of plaques of a molded composition having only one flake size.

### EXAMPLE 2

A resinous composition was prepared comprising components (i)-(vi) of Example 1. In addition the composition comprised 1.5 phr ethylene bisstearamide and 0.03 phr carbon black. The composition was compounded by extrusion and evaluated by injection molding into test parts. Photographs of plaques of the molded composition showed greater variation in color per unit area and appeared to have a coarser texture when compared to photographs of plaques of a molded composition having only one flake size.

### EXAMPLE 3

A resinous composition was prepared comprising components (i)-(vi) of Example 1. In addition the composition comprised 1.5 phr ethylene bisstearamide, 0.03 phr carbon black, and 5 phr of a polymer comprising structural units derived from methyl methacrylate and butyl acrylate (available from Mitsubishi Rayon Co. under the tradename METABLEN® P552). The composition was compounded by extrusion and evaluated by injection molding into test parts. Photographs of plaques of the molded composition showed greater variation in color per unit area and appeared to have a coarser texture when compared to photographs of plaques of a molded composition not including METABLEN®.

### EXAMPLE 4

A resinous composition was prepared comprising components (i)-(vi) of Example 1. In addition the composition comprised 1.5 phr ethylene bisstearamide, 0.03 phr carbon black, and 10 phr of a polymer comprising structural units derived from methyl methacrylate and butyl acrylate (available from Mitsubishi Rayon Co. under the tradename METABLEN® P552). The composition was compounded by extrusion and evaluated by injection molding into test parts. Photographs of plaques of the molded composition showed greater variation in color per unit area and appeared to have a coarser texture when compared to photographs of plaques of a molded composition not including METABLEN®.

### EXAMPLE 5

A resinous composition was prepared comprising components (i)-(vi) of Example 1. In addition the composition comprised 1.5 phr ethylene bisstearamide, 0.2 phr red pigment, 0.3 phr green pigment, and 5 phr of a polymer comprising structural units derived from methyl methacrylate and butyl acrylate (available from Mitsubishi Rayon Co. under the tradename METABLEN® P552). The composition was compounded by extrusion and evaluated by injection molding into test parts. Photographs of plaques of the molded composition showed greater variation in color per unit area and appeared to have a coarser texture when compared to photographs of plaques of a molded composition not including METABLEN®.

### EXAMPLE 6

A resinous composition was prepared comprising (i) 35 parts per hundred parts resin (phr) ASA powder, (ii) 65 phr MMASAN pellets, (iii) 6.5 phr glass roving, and (iv) a blend of aluminum flake 1 and aluminum flake 3 in a wt./wt. ratio of 1:2. The composition also comprised (vi) 1.65 phr of an additive package comprising a lubricant, heat stabilizers, and anti-oxidants which did not significantly affect the appearance of molded parts. The composition was compounded by extrusion and evaluated by injection molding into test parts. Photographs of plaques of the molded composition showed greater variation in color per unit area and appeared to have a coarser texture when compared to photographs of plaques of a molded composition having only one flake size.

### EXAMPLE 7

A resinous composition was prepared comprising 35 parts per hundred parts resin (phr) ASA powder, 65 phr MMASAN pellets, 6.5 phr glass roving, and 4 phr mica flake with particle size range of 10-60 microns (IRIODIN® 100 available from EMD Chemicals, Hawthorne, N.Y.). The composition also comprised 1.65 phr of an additive package comprising a lubricant, heat stabilizers, and anti-oxidants which did not significantly affect the appearance of molded parts. In addition the composition comprised 1.5 phr ethylene bisstearamide, 0.03 phr carbon black, and 5 phr of a polymer comprising structural units derived from methyl methacrylate and butyl acrylate (available from Mitsubishi Rayon Co. under the tradename METABLEN® P552). The composition was compounded by extrusion and evaluated by injection molding into test parts. Photographs of plaques of the molded composition showed greater variation in color per unit area and appeared to have a coarser texture when compared to photographs of plaques of a molded composition not including METABLEN®.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All Patents and published articles cited herein are incorporated herein by reference.

1. A formed article exhibiting a special visual effect derived from a composition comprising (i) at least one of an ASA resin or a methyl methacrylate-modified ASA resin present in an amount in a range of between about 10 phr and about 80 phr, (ii) at least one thermoplastic resin selected from the group consisting of SAN, MMASAN, AMSAN, and PMMA, (iii) at least one of glass roving or glass fiber present in an amount in a range of between about 2 phr and about 25 phr, and (iv) a mixture of special visual effect additives selected from the group consisting of metallic flakes, dyed metallic flakes, mineral flakes, dyed mineral flakes, mineral flakes with a metallic coating, and mineral flakes with a metal oxide coating, wherein the mixture comprises at least two different mean particle sizes of additives with one size ranging from about 12 to about 25 microns and another size of greater than about 30 microns, wherein the mixture is present in a total amount in a range of between about 0.05 phr and about 8 phr, and wherein the ratio of the number of particles per unit volume of a special visual effect additive of larger mean particle size to the number of particles per unit volume of a special visual effect additive of smaller mean particle size is in a range of between about 0.1 and about 1.

2. The formed article of claim 1, wherein the thermoplastic resin is MMASAN.

3. The formed article of claim 1, wherein the special visual effect additive mixture comprises aluminum flakes.

4. The formed article of claim 1, wherein the composition further comprises at least one additive selected from the group consisting of colorants, dyes, pigments, lubricants, processing aids, stabilizers, heat stabilizers, light stabilizers, antioxidants, UV screeners, UV absorbers, fillers, poly(tetrafluoroethylene), and mixtures thereof.

5. The formed article of claim 4, wherein the colorant is an organic additive.

6. The formed article of claim 5, wherein the organic additive is present at a level in a range of between 0.01 phr and 1 phr.

7. The formed article of claim 1, wherein the composition further comprises ethylene bisstearamide or an acrylic copolymer resin processing aid or a mixture thereof.

8. A formed article exhibiting a special visual effect derived from a composition comprising (i) at least one of an ASA resin or a methyl methacrylate-modified ASA resin present in an amount in a range of between about 10 phr and about 80 phr, (ii) at least one thermoplastic resin selected from the group consisting of SAN, MMASAN, AMSAN, and PMMA, (iii) at least one of glass roving or glass fiber present in an amount in a range of between about 2 phr and about 25 phr, (iv) mica present in an amount in a range of between about 1 phr and about 10 phr, and (v) an acrylic copolymer resin processing aid present in an amount in a range of between about 2 phr and about 10 phr.

9. The formed article of claim 8, wherein the thermoplastic resin is MMASAN.

10. The formed article of claim 8, wherein the composition further comprises at least one additive selected from the group consisting of colorants, dyes, pigments, lubricants, processing aids, ethylene bisstearamide, stabilizers, heat stabilizers, light stabilizers, antioxidants, UV screeners, UV absorbers, fillers, poly(tetrafluoroethylene), and mixtures thereof.

11. The formed article of claim 10, wherein the colorant is an organic additive.

12. The formed article of claim 11, wherein the organic additive is present at a level in a range of between 0.01 phr and 1 phr.
